(19) United States
(12) Patent Application Publication
(10) Pub. No.: US 2013/0180948 A1
(43) Pub. Date: Jul. 18, 2013

(54) MAGNETIC RECORDING MEDIUM AND METHOD OF MANUFACTURING THE SAME

(71) Applicants: Kazutaka TAKIZAWA, Fuchu-shi (JP); Akira WATANABE, Kawasaki-shi (JP); Kaori KIMURA, Yokohama-shi (JP); Takeshi IWASAKI, Inagi-shi (JP); Tsuyoshi ONITSUKA, Hino-shi (JP); Akihiko TAKEO, Kunitachi-shi (JP)

(72) Inventors: Kazutaka TAKIZAWA, Fuchu-shi (JP); Akira WATANABE, Kawasaki-shi (JP); Kaori KIMURA, Yokohama-shi (JP); Takeshi IWASAKI, Inagi-shi (JP); Tsuyoshi ONITSUKA, Hino-shi (JP); Akihiko TAKEO, Kunitachi-shi (JP)

(73) Assignee: KABUSHIKI KAISHA TOSHIBA, Tokyo (JP)

(21) Appl. No.: 13/560,183

(22) Filed: Jul. 27, 2012

(30) Foreign Application Priority Data
Jan. 13, 2012 (JP) 2012-005059

(51) Int. Cl. G11B 5/84

(52) U.S. Cl. 216/22; 427/130

(57) ABSTRACT

According to one embodiment, a release layer is formed on a magnetic recording layer, a mask layer is formed on the release layer, projecting patterns are formed on the mask layer, the projecting patterns are transferred onto the mask layer, the projecting patterns are transferred onto the release layer, the projecting patterns are transferred onto the magnetic recording layer, the release layer is removed by a solvent, and a remaining mask layer is removed from the surface of the magnetic recording layer. The release layer is made of a polymeric material. The mask layer is made of at least one of a metal or a metal compound. The projecting patterns are formed by using a self-organized layer made of a block copolymer having at least two of polymer chains.

### CROSS-REFERENCE TO RELATED APPLICATIONS

This application is based upon and claims the benefit of priority from prior Japanese Patent Application No. 2012-005059, filed Jan. 13, 2012, the entire contents of which are incorporated herein by reference.

### FIELD

Embodiments described herein relate generally to a magnetic recording medium and a method of manufacturing the same.

### BACKGROUND

Recently, the amount of information to be processed by information communication apparatuses is constantly increasing, and strong demands have arisen for implementing a large-capacity recording device. To increase the recording density of an HDD (Hard Disk Drive), the development of various techniques such as perpendicular magnetic recording has been advanced. In addition, a discrete track medium and bit patterned medium in which recording patterns are isolated in a plane have been proposed as media capable of increasing both the recording density and thermal decay resistance, and it is indispensable to develop the manufacturing techniques of these media.

To record one-bit information in one magnetic recording cell as in the bit patterned medium, it is only necessary to magnetically isolate individual cells. In many cases, therefore, magnetic dot portions and nonmagnetic dot portions are formed in a plane based on a micropatterning technique.

More specifically, a magnetic recording layer on a substrate is isolated by applying a semiconductor manufacturing technique. For example, a patterning mask is deposited on the magnetic recording layer, and projecting patterns are formed on the patterning mask and transferred onto the magnetic recording layer, thereby obtaining a magnetic recording medium in which recording patterns are isolated by projections.

The projections are formed on the mask pattern by using a versatile resist material of semiconductor fabrication. Examples are a method of obtaining fine patterns by selectively modifying the resist material by irradiation with an energy line, a method of patterning a self-organized layer formed by arranging patterns having different chemical properties in the resist film, and a method of physically imprinting and patterning projections.

There is still another method by which after mask patterns are formed, ions irradiated with high energy are implanted into a magnetic recording layer to selectively deactivate the magnetism of the patterns, thereby obtaining a medium in which the recording patterns are magnetically isolated via a non-recording region.

When a magnetic head for performing write or read to the magnetic recording medium is to be scanned on the medium, if the mask patterns remain on the magnetic recording layer, the projections as magnetic dots become higher, and this causes head crush. Also, if the distance between the magnetic recording layer and magnetic head is large, a signal S/N detectable by the magnetic head decreases. After the magnetic recording layer is patterned, therefore, it is necessary to decrease the height of the projections by removing the mask patterns on the magnetic recording layer. In an actual process, a release layer is generally formed between the magnetic recording layer and mask layer.

An example of a bit patterned medium releasing process is a method of removing a carbon release layer by dry etching. Unfortunately, this method poses the problem that oxygen as an etching gas oxidizes the magnetic recording layer and deteriorates the magnetic characteristics of the recording layer. Also, if a gigantic residue equal to or larger than the projection pattern width of the mask layer exists, it is difficult to remove the residue by dry etching, and the residue readily forms an unremoved portion and remains as a projecting pattern on the medium. This makes it difficult to obtain a medium maintaining the in-plane uniformity.

On the other hand, unlike dry removal, wet removal isotropically removes a release layer when a release solution comes in contact with the release layer, and hence can remove a gigantic residue that cannot be removed by dry removal. Accordingly, an example of wet removal is a method of removing a silicon-containing polymer as a release layer by using an organic solvent.

When using a silicon-containing polymer as a release layer, however, a thermal energy is applied to the release layer by, e.g., deposition or etching of a mask layer. Since this promotes a crosslinking reaction, the release layer significantly hardens. Consequently, many unremoved portions are formed because the solubility to a solution decreases, and the process cost increases because the removal time prolongs.

### BRIEF DESCRIPTION OF THE DRAWINGS

FIG. 1 is an exemplary sectional view showing a manufacturing step of a magnetic recording medium of an embodiment;

FIG. 2 is an exemplary sectional view showing a manufacturing step of the magnetic recording medium of the embodiment;

FIG. 3 is an exemplary sectional view showing a manufacturing step of the magnetic recording medium of the embodiment;

FIG. 4 is an exemplary sectional view showing a manufacturing step of the magnetic recording medium of the embodiment;

FIG. 5 is an exemplary sectional view showing a manufacturing step of the magnetic recording medium of the embodiment;

FIG. 6 is an exemplary sectional view showing a manufacturing step of the magnetic recording medium of the embodiment;

FIG. 7 is an exemplary sectional view showing a manufacturing step of the magnetic recording medium of the embodiment;

FIG. 8 is an exemplary sectional view showing a manufacturing step of an example of a magnetic recording medium according to the first embodiment;

FIG. 9 is an exemplary sectional view showing a manufacturing step of the example of the magnetic recording medium according to the first embodiment;

FIG. 10 is an exemplary sectional view showing a manufacturing step of the example of the magnetic recording medium according to the first embodiment;

FIG. 11 is an exemplary sectional view showing a manufacturing step of the example of the magnetic recording medium according to the first embodiment;

FIG. 12 is an exemplary sectional view showing a manufacturing step of the example of the magnetic recording medium according to the first embodiment;

FIG. 13 is an exemplary sectional view showing a manufacturing step of the example of the magnetic recording medium according to the first embodiment;

FIG. 14 is an exemplary sectional view showing a manufacturing step of the example of the magnetic recording medium according to the first embodiment;

FIG. 15 is an exemplary sectional view showing a manufacturing step of the example of the magnetic recording medium according to the first embodiment;

FIG. 16 is an exemplary sectional view showing a manufacturing step of the example of the magnetic recording medium according to the first embodiment;

FIG. 17 is an exemplary sectional view showing a manufacturing step of the example of the magnetic recording medium according to the first embodiment;

FIG. 18 is an exemplary sectional view showing an example of a manufacturing step of a magnetic recording medium according to the second embodiment;

FIG. 19 is an exemplary sectional view showing an example of the manufacturing step of the magnetic recording medium according to the second embodiment;

FIG. 20 is an exemplary sectional view showing an example of the manufacturing step of the magnetic recording medium according to the second embodiment;

FIG. 21 is an exemplary sectional view showing an example of the manufacturing step of the magnetic recording medium according to the second embodiment;

FIG. 22 is an exemplary sectional view showing an example of the manufacturing step of the magnetic recording medium according to the second embodiment;

FIG. 23 is an exemplary sectional view showing an example of the manufacturing step of the magnetic recording medium according to the second embodiment;

FIG. 24 is an exemplary sectional view showing an example of the manufacturing step of the magnetic recording medium according to the second embodiment;

FIG. 25 is an exemplary sectional view showing an example of the manufacturing step of the magnetic recording medium according to the second embodiment;

FIG. 26 is an exemplary sectional view showing an example of the manufacturing step of the magnetic recording medium according to the second embodiment;

FIG. 27 is an exemplary sectional view showing an example of the manufacturing step of the magnetic recording medium according to the second embodiment;

FIG. 28 is an exemplary sectional view showing an example of a manufacturing step of a magnetic recording medium according to the third embodiment;

FIG. 29 is an exemplary sectional view showing an example of the manufacturing step of the magnetic recording medium according to the third embodiment;

FIG. 30 is an exemplary sectional view showing an example of the manufacturing step of the magnetic recording medium according to the third embodiment;

FIG. 31 is an exemplary sectional view showing an example of the manufacturing step of the magnetic recording medium according to the third embodiment;

FIG. 32 is an exemplary sectional view showing an example of the manufacturing step of the magnetic recording medium according to the third embodiment;

FIG. 33 is an exemplary sectional view showing an example of the manufacturing step of the magnetic recording medium according to the third embodiment;

FIG. 34 is an exemplary sectional view showing an example of the manufacturing step of the magnetic recording medium according to the third embodiment;

FIG. 35 is an exemplary sectional view showing an example of the manufacturing step of the magnetic recording medium according to the third embodiment;

FIG. 36 is an exemplary sectional view showing an example of the manufacturing step of the magnetic recording medium according to the third embodiment;

FIG. 37 is a graph showing the changes in magnetostatic characteristic before and after a magnetic recording material of an embodiment is dipped in organic solvents;

FIG. 38 is a graph showing the changes in magnetostatic characteristic before and after the magnetic recording material of the embodiment is dipped in the organic solvents; and

FIG. 39 is a view showing examples of recording bit patterns in the circumferential direction of a magnetic recording medium.

### DETAILED DESCRIPTION

In general, a magnetic recording medium manufacturing method according to an embodiment is divided into three embodiments.

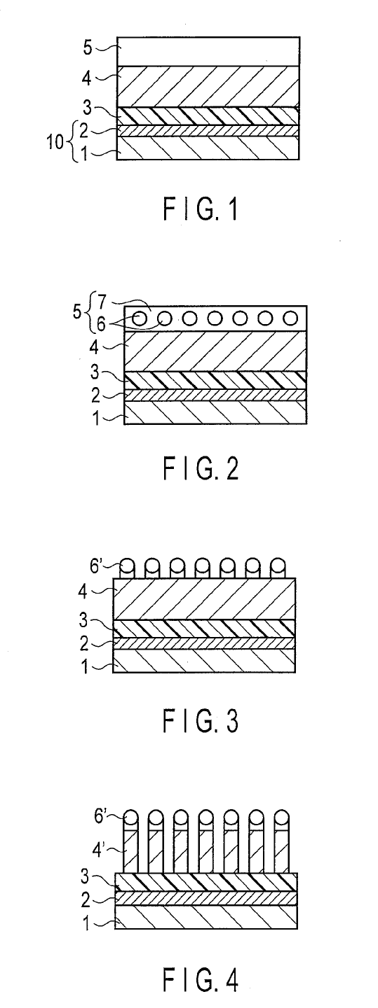

FIGS. 1, 2, 3, 4, 5, 6, 7, and 8 are exemplary sectional views showing manufacturing steps of an example of a magnetic recording medium according to the first embodiment.

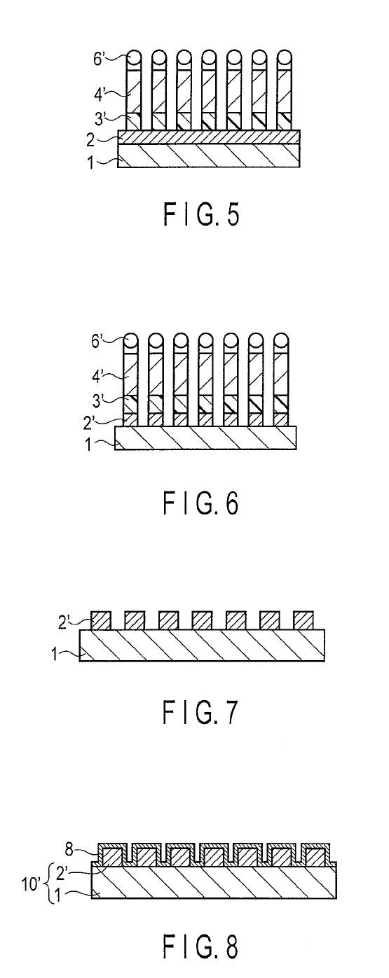

A method of manufacturing the magnetic recording medium according to the first embodiment includes a step of obtaining a magnetic recording medium 10 by forming a magnetic recording layer 2 on a substrate 1, a step of forming a release layer 3 on the magnetic recording layer 2, a step of forming a mask layer 4 on the release layer 3, a step (FIG. 3) of forming projecting patterns 6′ on the mask layer 4, a step (FIG. 4) of transferring the projecting patterns 6′ onto the mask layer 4, a step (FIG. 5) of transferring the projecting patterns 6′ and projecting patterns 4′ onto the release layer 3, a step (FIG. 6) of transferring the projecting patterns 6′ and 4′ and projecting patterns 3′ onto the magnetic recording layer 2, and a step (FIG. 7) of removing the release layers 3′ by a solvent, and removing the mask layers 6′ and 4′ remaining on the magnetic recording layers 2′. A protective layer 8 can be formed after the release layers 3′ are removed (FIG. 8).

In the first embodiment, the release layer 3 is made of a polymeric material. The mask layer 4 is made of at least one of a metal or a metal compound. The projecting patterns 6′ are formed by using a self-organized layer 5 made of a block copolymer having at least two of polymer chains. The self-organized layer 5 is formed on the mask layer 4 (FIG. 1), and the substrate 1 is annealed to planarize the release layer 3 and form micro phase-separated structures 6 and 7 in the self-organized layer 5 (FIG. 2). After that, a polymer layer 7 as one of the micro phase-separated structures 6 and 7 is selectively removed. Consequently, the remaining polymer layer 6 forms the projecting patterns 6′ (FIG. 3).

A magnetic recording medium manufacturing method according to the second embodiment includes a step of forming a magnetic recording layer on a substrate, a step of forming a first mask layer (intermediate mask layer) on the magnetic recording layer, a step of forming a release layer on the first mask layer, a step of forming a second mask layer (mask layer) on the release layer, a step of forming projecting patterns on the second mask layer, a step of transferring the projecting patterns onto the second mask layer, a step of transferring the projecting patterns onto the release layer, a step of transferring the projecting patterns onto the magnetic recording layer, a step of removing the release layer by a solvent and removing the remaining second mask layer from the surface of the first mask layer, and a step of removing the first mask layer from the surface of the magnetic recording layer.

The magnetic recording medium manufacturing method according to the second embodiment is the same as the method according to the first embodiment, except that this method further includes the step of forming an intermediate mask layer before the step of forming the release layer, further includes the step of transferring the projecting patterns onto the intermediate mask layer before the step of transferring the projecting patterns onto the magnetic recording layer, and further include the step of removing the intermediate mask layer from the surface of the magnetic recording layer after the step of removing the release layer.

A magnetic recording medium manufacturing method according to the third embodiment includes a step of forming a magnetic recording layer on a substrate, a step of forming a first mask layer on the magnetic recording layer, a step of forming a release layer on the first mask layer, a step of forming a second mask layer on the release layer, a step of forming projecting patterns on the second mask layer, a step of transferring the projecting patterns onto the second mask layer, a step of transferring the projecting patterns onto the release layer, a step of removing the release layer by a solvent and removing the remaining second mask layer from the surface of the first mask layer, a step of transferring the projecting patterns onto the magnetic recording layer, and a step of removing the first mask layer from the surface of the magnetic recording layer.

The magnetic recording medium manufacturing method according to the third embodiment is the same as the method of the first embodiment, except that this method further includes the step of forming an intermediate mask layer before the step of forming the release layer, further includes the step of transferring the projecting patterns onto the intermediate mask layer before the step of transferring the projecting patterns onto the magnetic recording layer, and moves the step of removing the release layer by a solvent and removing the remaining mask layer from the surface of the intermediate mask layer, between the step of transferring the projecting patterns onto the intermediate mask layer and the step of transferring the projecting patterns onto the magnetic recording layer.

In the second and third embodiments, the first and second mask layers are made of at least one of a metal or a metal compound. The materials of the first and second mask layers can be different. The release layer is made of a polymeric material. The projecting patterns are formed by using a self-organized layer made of a block copolymer having at least two of polymer chains. The self-organized layer is formed on the mask layer, and the substrate is annealed to planarize the release layer and form the micro phase-separated structures in the self-organized layer. After that, a polymer layer as one of the micro phase-separated structures is selectively removed. Consequently, the remaining polymer layer forms the projecting patterns.

In the magnetic recording medium manufacturing methods according to the first to third embodiments, the polymeric release layer is removed from the surface of the magnetic recording layer by using an organic solvent or water. In the magnetic recording medium manufacturing methods according to the first to third embodiments, the HDI (Head Disk Interface) characteristic improves because the mask pattern removability is high, and a magnetic recording medium having excellent magnetic characteristics is obtained because almost no damage is inflicted to the magnetic recording layer. In wet removal, an organic solvent or water is used as a release solution, and a polymeric release layer is removable by the solvent or water is formed on the magnetic recording layer. Also, when the whole substrate is annealed in order to form the micro phase-separated structures in the self-organized layer, the polymeric release layer is also annealed and fluidized. This improves the flatness of the magnetic recording medium, and makes it possible to improve the pattern in-plane uniformity. In this case, the number of steps is reduced because the release layer is annealed by the annealing process necessary to form the micro phase-separated structures in the self-organized layer. Furthermore, the mask layer on the polymeric release layer is made of a material containing a metal or metal compound in order to transfer the self-organized patterns onto the release layer and magnetic recording layer at a high selectivity.

Note that when using water as the release solution, the environmental load is lower than that in the process using an organic solvent. In addition, the manufacturing cost of the chemical is reduced, and the washing time is shortened. This improves the manufacturing throughput.

### First Embodiment

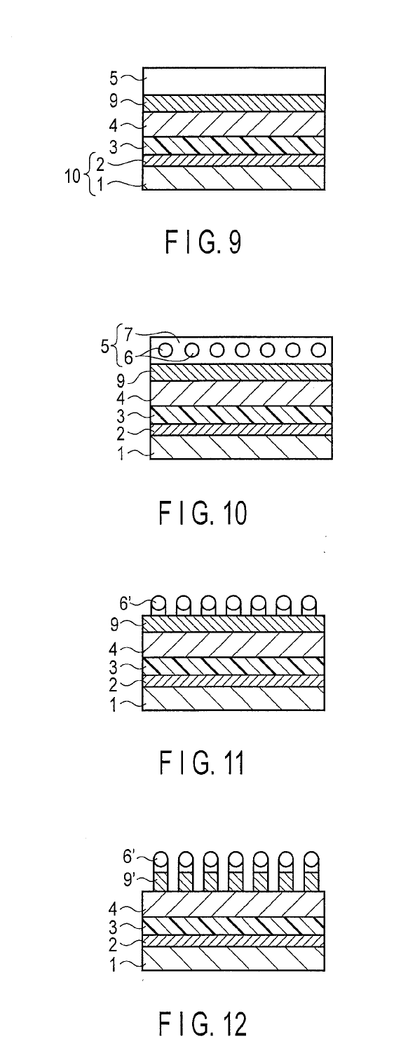

FIGS. 9, 10, 11, 12, 13, 14, 15, 16, and 17 are exemplary sectional views showing manufacturing steps of the magnetic recording medium according to the first embodiment.

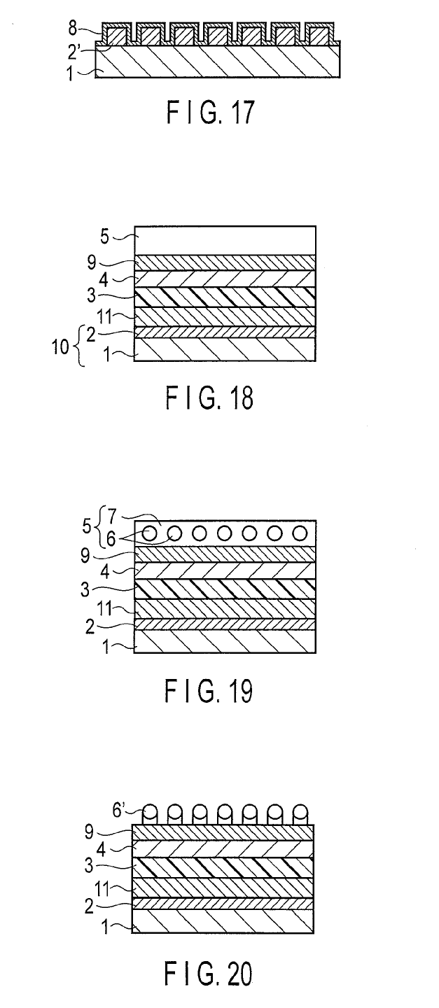

In the magnetic recording medium manufacturing method according to the first embodiment, as shown in FIG. 9, a perpendicular magnetic recording layer 2, polymeric release layer 3, metal mask layer 4, pattern transfer layer 9, and self-organized layer 5 are sequentially deposited on a substrate 1. After that, steps shown in FIGS. 10, 11, 12, 13, 14, and 15 are performed, projecting patterns formed on the self-organized layer 5 are transferred onto the perpendicular magnetic recording layer 2 as shown in FIG. 16, and the polymeric release layer 3 is removed by an organic solvent or water as shown in FIG. 17, thereby obtaining a magnetic recording medium 10′ including the perpendicular magnetic recording layer 2′ having a projecting pattern shape.

### Magnetic Recording Layer Formation Step

First, a magnetic recording medium 10 is obtained by forming the perpendicular magnetic recording layer 2 on the substrate 1. Although the shape of the substrate is not limited at all, the substrate is normally circular and made of a hard material. Examples are a glass substrate, metal-containing substrate, carbon substrate, and ceramic substrate. To improve the pattern in-plane uniformity, projections on the substrate surface are desirably small. It is also possible to form a protective film such as an oxide film on the substrate surface as needed. As the glass substrate, it is possible to use amorphous glass such as soda lime glass or aluminosilicate glass, or crystallized glass such as lithium-based glass. Furthermore, a sintered substrate mainly containing alumina, aluminum nitride, or silicon nitride can be used as the ceramic substrate.

The perpendicular magnetic recording layer mainly containing cobalt is formed on the substrate. A soft under layer (SUL) having a high magnetic permeability can be formed between the substrate and perpendicular magnetic recording layer. The soft under layer returns a recording magnetic field from a magnetic head for magnetizing the perpendicular magnetic recording layer, i.e., performs a part of the magnetic head function. The soft under layer applies a sufficient perpendicular magnetic field having a steep intensity slope to the recording layer, thereby increasing the recording/reproduction efficiency. A material containing Fe, Ni, or Co can be used as the soft under layer. As the material of the soft under layer, it is also possible to use an amorphous material having none of magnetocrystalline anisotropy, a crystal defect, and a grain boundary, and showing a high soft magnetism. The amorphous material can reduce the noise of the recording medium. An example of this amorphous material is a Co alloy mainly containing Co and also containing at least one of Zr, Nb, Hf, Ti, and Ta, and it is possible to select CoZr, CoZrNb, or CoZrTa.

In addition, a base layer for improving the adhesion of the soft under layer can be formed between the soft under layer and substrate. Examples of the base layer material are Ni, Ti, Ta, W, Cr, Pt, and alloys, oxides, and nitrides containing these elements. For example, it is possible to use NiTa or NiCr. Note that the base layer can include a plurality of layers.

Furthermore, an interlayer made of a nonmagnetic metal material can be formed between the soft under layer and perpendicular magnetic recording layer. The interlayer has two functions: one is to interrupt the exchange coupling interaction between the soft under layer and perpendicular magnetic recording layer; and the other is to control the crystallinity of the perpendicular magnetic recording layer. As the interlayer material, it is possible to use Ru, Pt, Pd, W, Ti, Ta, Cr, Si, or an alloy, oxide, or nitride containing any of these elements.

The perpendicular magnetic recording layer mainly contains Co, also contains at least Pt, and can further contain a metal oxide. The layer can also contain one or more elements selected from B, Ta, Mo, Cu, Nd, W, Nb, Sm, Tb, and Ru. When these elements are contained, it is possible to promote downsizing of magnetic grains, improve the crystallinity and alignment, and obtain recording/reproduction characteristics and thermal decay characteristics more suitable for a high recording density. Practical examples of the material usable as the perpendicular magnetic recording layer are alloys such as a CoPt-based alloy, a CoCr-based alloy, a CoCrPt-based alloy, CoPtO, CoPtCrO, CoPtSi, CoPtCrSi, and CoCrSiO₂.

The thickness of the perpendicular magnetic recording layer can be set to 5 nm or more in order to measure a reproduced output signal with high accuracy, and can be set to 40 nm or less in order to suppress the distortion of the signal intensity. If the thickness is smaller than 5 nm, the reproduced output is extremely low, and the noise component becomes dominant. On the other hand, if the thickness is larger than 40 nm, the reproduced output becomes excessive, and the signal waveform is distorted.

### Polymeric Release Layer Formation Step

Subsequently, the polymeric release layer 3 is formed on the perpendicular magnetic recording layer 2. The embodiment uses a release layer made of a polymeric material. Examples of the polymeric material are a novolak resin as a versatile resist material, polystyrene, polymethylmethacrylate, methylstyrene, polyethylene terephthalate, and polyhydroxystyrene. These materials may also be composite materials containing a metal in order to increase the etching resistance. The polymeric release layer is removed by an organic solvent, thereby finally achieving a function of removing the mask material formed on the release layer from the surface of the perpendicular magnetic recording layer.

This release layer can be formed not only on the perpendicular magnetic recording layer, but also on a transfer mask formed on the perpendicular magnetic recording layer. For example, layers can be formed in the order of the release layer/metal mask layer on a Si film. In this case, even when an unremoved residue is formed, the residue can be removed by removing the transfer mask as a lower layer. This makes it possible to increase the pattern uniformity.

A water-soluble polymeric material can also be selected as the polymeric release layer. Practical examples of the water-soluble polymeric material are polyacrylic acid, polyarylic acid, polyamic acid, polyethylenesulfonic acid, polystyrenesulfonic acid, maleic acid, polyamide, polyacrylamide, polyamidoamine, polymethylacrylamide, polyvinyl alcohol, polyvinylacetal, polyvinylpyrrolidone, polyvinylamine, polyethyleneglycol, polyethyleneimine, polyethyleneoxide, methylcellulose, ethylcellulose, hydroxycellulose, carboxymethylcellulose, hydroxyethylcellulose, and hydroxypropylcellulose. It is also possible to apply a block copolymer material in which different polymers are bonded.

While these polymeric materials are soluble in water, Co-based magnetic recording layer materials are sparingly soluble in water, so almost no recording layer material dissolves during wet removal. Accordingly, it is possible to minimize the deterioration of the magnetic recording/reproduction characteristics, and decrease the environmental load when using water as a release solution instead of an organic solvent. Also, since no hazardous material is used, it is possible to improve the safety of manufacturing steps, reduce the numbers of times of solution replacement and washing during release solution washing, reduce the cost of the release solution, and increase the manufacturing throughput by shortening the washing time.

The polymeric release layer may also have a multilayered structure including two or more layers having different compositions, provided that the layers are soluble in an organic solvent or water. Even when the materials of the individual layers are mixed, no essential problem can arise as long as the layers can be dissolved away by the release solution. Therefore, various materials can selectively be combined.

The release layer can be formed on the perpendicular magnetic recording layer by, e.g., spin coating, spray coating, spin casting, dip coating, die coating, or an inkjet method. The film thickness of the polymeric release layer can appropriately be changed in accordance with the coating conditions, e.g., the concentration of a polymeric release layer precursor solution, the rotational speed set during deposition, and the coating time. Also, to accurately form a thin film about a few nm thick, defects like pinholes are sometimes formed in a large area. To prevent this, a thick film about a few ten nm thick is deposited in advance, and uniformly etched in a plane. Since the film thickness can be reduced by this process, a release layer having few local pinholes can be formed.

Dry etching can make it easier, than by wet etching, to adjust the film thickness at an accuracy of a few nm. In this case, it is necessary to optimally select an etching solution or etching gas in order to prevent the surface of the polymeric release layer from being modified and becoming insoluble in a solvent. This problem can be solved by using, e.g., O₂ as an etching gas.

Furthermore, as the contact area between the release layer and release solution increases, the dissolution of the release layer is promoted. Accordingly, the removability of the release layer improves as the thickness of the layer increases. From the viewpoint of patterning, the thickness of the release layer can be set to 5 to 20 nm. If the thickness is less than 5 nm, the removability deteriorates, and an unremoved residue often forms on the medium. On the other hand, if the thickness exceeds 20 nm, the pattern aspect ratio increases, and the projecting patterns often collapse.

When using an organic solvent or water as the release solution, the release solution penetrates from the pattern side surfaces of the polymeric release layer having projections, and the dissolving reaction advances. In this process, the end portion of the pattern region is exposed to the release solution and hence has removability higher than that of the projecting pattern portion. Therefore, the projecting patterns are gradually removed from this region toward the substrate center. As described above, the removability can be improved when the release layer is thick. Accordingly, the film thickness of the release layer is made larger in the vicinity of the end portion of the substrate than in the vicinity of the center. This makes it possible to increase the contact area with respect to the release solution, and further improve the removability of the mask patterns. This similarly applies to a process when using a doughnut-like disk substrate. That is, the release layer is formed such that the film thickness on the inner circumference and outer circumference of the substrate is larger than that near the middle circumference. Also, during etching or milling, active species or ions are concentrated to the vicinity of the substrate end portion, and this sometimes increases the etching rate and produces process variations of the projecting patterns. However, it is possible to compensate for the net etching amount and implement uniform processing in a plane by making the release layer thickness near the substrate end portion larger than that near the substrate center.

### Mask Layer Formation Step

The mask layer 4 for transferring the projecting patterns is formed on the release layer 3. The mask layer 4 is used to physically and chemically transfer the projections of the self-organized layer 5 as an upper layer onto the release layer 3 and perpendicular magnetic recording layer 2. The mask layer 4 is made of at least one of a metal or a metal compound so as to be able to maintain the etching selectivity when transferring the projections onto the perpendicular magnetic recording layer 2. The metal compound can also be formed of an oxide, nitride, carbide, boride, or alloy containing a given metal as a main element.

The metal as the mask layer material can be selected from various metals in accordance with the etching material or etching method. Examples are Al, Si, Ti, V, Cr, Mn, Co, Ni, Cu, Zn, Ga, Zr, Nb, Mo, Ru, Pd, Ag, Hf, Ta, W, Pt, and Au. Materials made of compounds or alloys of these metals can be applied to the mask layer. In this case, it is only necessary to properly determine a mask material and its film thickness capable of maintaining the etching selectivity to the projecting patterns of the self-organized layer to be formed on the mask layer.

Also, the mask layer can have a multilayered structure including a first layer that can be etched, and a second layer made of a material different from that of the first layer. In this case, it is favorable to optimally select metal materials corresponding to the etching solution or etching gas. When combining materials from the group of metals by assuming dry etching, examples are Si/Al, Si/Ni, Si/Cu, Si/Mo, Si/MoSi₂, Si/Ta, Si/Cr, Si/W, Si/Ti, Si/Ru, and Si/Hf from the substrate side. Si may also be replaced with SiO₂, Si₃N₄, or SiC. It is also possible to select a multilayered structure such as Al/Ni, Al/Ti, Al/TiO₂, Al/TiN, Cr/Al₂O₃, Cr/Ni, Cr/MoSi₂, Cr/W, GaN/Ni, GaN/NiTa, GaN/NiV, Ta/Ni, Ta/Cu, Ta/Al, or Ta/Cr. The mask material combinations and stacking orders are not limited to those described above, and can properly be selected from the viewpoints of the pattern dimensions and etching selectivity. Furthermore, since projection patterning can also be performed by wet etching as well as dry etching, each mask material can be selected by taking this factor into consideration.

When, for example, a carbon film as a non-metal mask layer is formed on the polymeric release layer, macro projections are formed by stress produced in the polymeric release layer and carbon film, and the in-plane uniformity of the medium decreases. However, this can be improved by using a metal-based material as the mask layer. More specifically, it is possible to reduce the stress in the mask layer interface and reduce the surface roughness by using Si film instead of the carbon film.

Note that it is also possible to use a two-layered structure including the release layer and metal mask layer as a unit, and form multiple units on the perpendicular magnetic recording layer. When using multiple units, the thickness of each of the mask layer and release layer can be made smaller than that when using a single layer. Even if no etching selectivity can be secured in projecting pattern transfer to a thick film, the thin-film multilayered structure makes it possible to perform projecting pattern transfer while securing the etching selectivity, because the etching depth of each layer need only be small.

The metal mask layer can be formed by physical vapor deposition (PVD) such as vacuum deposition, electron beam deposition, molecular beam deposition, ion beam deposition, ion plating, or sputtering, or chemical vapor deposition (CVD) using heat, light, or plasma. The thickness can appropriately be adjusted by taking account of the pitch, height, and density of the projecting patterns. Also, the transfer uniformity of the projecting patterns of the upper layer largely depends on the surface roughness of the mask layer. Therefore, it is possible to form the metal mask layer so as to reduce the surface roughness, and form an amorphous mask layer rather than a crystalline mask layer.

### Self-Organization Layer Formation Step

Subsequently, the self-organized layer 5 for forming the projecting patterns is formed on the mask layer 4. The self-organized layer 5 is typically a diblock copolymer having at least two different polymer chains. This diblock copolymer has a basic structure in which the ends of polymers having different chemical characteristics are covalently bonded like (block A)-(block B). The self-organized layer 5 is not limited to the diblock copolymer, and can also be a triblock copolymer or random copolymer.

Examples of the material forming the polymer block are polyethylene, polystyrene, polyisoprene, polybutadiene, polypropyrene, polydimethylsiloxane, polyvinylpyridine, polymethylmethacrylate, polybutylacrylate, polybutylmethacrylate, polydimethylacrylamide, polyethyleneoxide, polypropyreneoxide, polyacrylic acid, polyethylacrylic acid, polypropylacrylic acid, polymethacrylic acid, polylactide, polyvinylcarbazole, polyethyleneglycol, polycaprolactone, polyvinylidene fluoride, and polyacrylamide. The block copolymer can be formed by using two or more different polymers among these polymers.

The self-organized layer using the block copolymer can be deposited on the metal mask layer by using spin coating or the like. In this case, a solvent by which polymers forming individual phases are compatible to each other is selected, and a solution prepared by dissolving the polymers is used as a coating solution. Practical examples selectable as the solvent are toluene, xylene, hexane, heptane, octane, ethyleneglycol monoethylether, ethyleneglycol monomethylether, ethyleneglycol monomethyletheracetate, propyleneglycol monomethyletheracetate, ethyleneglycol trimethylether, ethyl lactate, ethyl pyruvate, cyclohexanone, tetrahydrofuran, anisole, and diethyleneglycol triethylether.

The film thickness of the self-organized layer can be changed to a desired value by changing the concentration of the coating solution when using any of these solvents, or various parameters to be set when performing deposition.

When energy such as heat is applied to the self-organized layer, the polymers cause phase separation, and form a micro phase-separated structure inside the film. The micro phase-separated structure looks different in accordance with, e.g., the molecular weights of polymers forming the self-organized layer. For example, as shown in FIG. 10, island-like dot or cylindrical structures 6 of polymer B are formed in a sea-like (matrix) pattern 7 of polymer A in a diblock copolymer. It is also possible to form a lamella structure in which polymers A and B are stacked, or a sphere structure in which the sea and island patterns are switched. The projections of the self-organized layer are formed by selectively removing one polymer phase in this pattern.

When forming the micro phase-separated structure of the self-organized layer, energy is externally intentionally applied. Examples of a method of applying energy are annealing using heat, and so-called solvent annealing by which a sample is exposed to a solvent ambient. When performing thermal annealing, the annealing temperature can properly be set so as not to deteriorate the arrangement accuracy of the self-organized layer, and so as not to decompose the above-mentioned polymeric release layer. A lower-limit temperature at which thermal annealing disorders the ordered pattern of the micro phase-separated structure is called an order-disorder transition temperature (ODT) of a self-organized material. The annealing temperature can be set lower than the order-disorder transition temperature of the self-organized layer, and lower than the decomposition temperature of the polymeric release layer. If the annealing temperature is higher than the order-disorder transition temperature, phase separation of the self-organized layer is disordered, and it is often impossible to transfer the projecting patterns. Also, if the annealing temperature is higher than the decomposition temperature of the polymeric release layer, it often becomes difficult to transfer and remove the projecting patterns.

Thermal annealing not only has the effect of forming the micro phase-separated structure of the self-organized layer, but also has the effect of improving the flatness of the medium. Since thermal annealing fluidizes the polymeric release layer, macro unevenness on the medium is reduced, and the pattern transfer accuracy can be improved. It is also possible to reduce the number of steps because prebaking of the release layer can be replaced with annealing of the self-organized layer.

Note that the upper portion of the mask layer can chemically be modified in order to improve the arrangement accuracy of the self-organized pattern. For example, the arrangement of the block copolymer can be improved by modifying, on the mask surface, any polymer phase forming the block copolymer. In this case, surface modification on a molecular level can be performed by polymer coating, annealing, and rinsing. Patterns having high in-plane uniformity can be obtained by coating this mask surface with the above-described block copolymer solution.

### Self-Organized Layer Patterning Step

Then, as shown in FIG. 11, projecting patterns 6′ are formed in the self-organized layer 5 by etching. The projecting patterns 6′ are formed by selectively removing a phase from the block copolymer. For example, in a polystyrene-b-polydimethylsiloxane-based diblock copolymer, patterns of island-like polydimethylsiloxane are formed in sea-like polystyrene by properly setting the molecular weight. Dot-like projecting patterns of polystyrene-b-polydimethylsiloxane are obtained by selectively removing one polymer layer by etching. Note that a pattern shape formable by using the block copolymer as described above is not limited to a dot, and a cylindrical structure or lamella structure can also be formed by adjusting a parameter such as the molecular weight. Therefore, the projecting patterns may also be formed by using these structures.

When forming the projections of the self-organized layer by etching, it is possible to apply wet etching by which a sample is dipped in a chemical liquid, and dry etching using a chemical reaction of active species. To precisely perform patterning in the thickness direction with respect to the width of fine patterns, it is possible to apply dry etching capable of suppressing etching in the widthwise direction.

In dry etching of a polymer phase, patterning can be performed while maintaining the etching selectivity by appropriately selecting active gas species. As a projection processing mask, it is generally possible to use a material having a high etching resistance, e.g., a material such as a benzene ring containing large amounts of C and H. The etching selectivity can be increased when using a material such as a block copolymer formed by appropriately combining polymers having different compositions, so the above-mentioned projecting patterns can be formed relatively easily. When using polystyrene-b-polydimethylsiloxane, for example, it is readily possible to remove polydimethylsiloxane by using a fluorine-based gas such as CF₄, and remove polystyrene by using O₂ gas. Accordingly, the etching selectivity can be secured between them.

If it is difficult to directly transfer the self-organized patterns onto the metal mask formed below the self-organized layer, another transfer layer can be formed between the self-organized layer and metal mask layer. For example, this transfer layer may be a mask material by which a common etching gas capable of removing one layer of the block copolymer is usable. When using polystyrene-b-polydimethylsiloxane, for example, polystyrene can be removed by O₂ etching, so it is possible to simultaneously etch the polymer and transfer layer by using only O₂ if a carbon film is used as the transfer layer. When the sea-like polymer is polydimethylsiloxane, etching is similarly possible by using CF₄ gas and Si as the transfer layer. By the process described above, the phase-separated patterns of the self-organized layer can be processed into a projecting shape.

If it is difficult to ensure the etching selectivity to the self-organized layer, the pattern transfer layer 9 can further be formed on the metal mask layer 4. It is possible to select a material by which the self-organized layer as an upper layer can be etched and apply the material to the transfer layer 9 in this case as well.

When the pattern transfer layer 9 is formed, as shown in FIG. 12, patterned transfer layers 9′ are obtained by transferring the projecting patterns 6′ of the self-organized layer onto the pattern transfer layer 9.

### Mask Layer Patterning Step

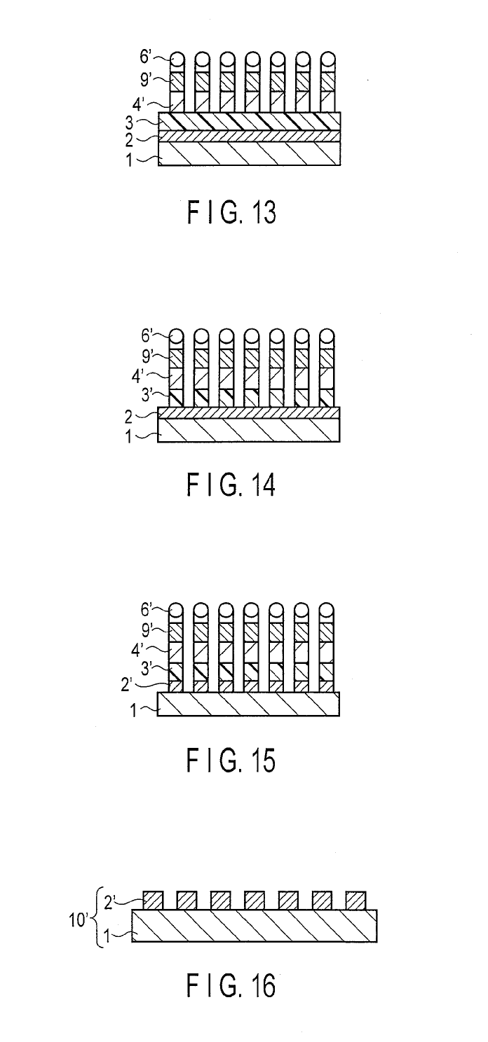

Subsequently, as shown in FIG. 13, patterned metal mask layers 4′ are obtained by transferring the projecting patterns 6′ of the self-organized layer onto the metal mask layer 4. The patterned metal mask layers 4′ desirably have a high processing resistance because they are used as masks for processing the perpendicular magnetic recording layer. That is, it is possible to select a metal material having an etching resistance higher than that of the perpendicular magnetic recording layer.

When processing the metal mask layer, it is possible to implement various layer arrangements and processing methods by combining a mask layer material and etching gas. There is a method using a multilayered mask containing Si and C in the same manner as for the diblock copolymer. Si has a high etching resistance to O₂ plasma, and a low etching resistance to F₂ plasma. By contrast, C has a high etching resistance to F₂ plasma, and a low etching resistance to O₂ plasma. Accordingly, the projecting patterns can be transferred onto the metal mask layer by performing processing in the same manner as for the diblock copolymer. When a Si mask is formed below the C transfer layer/self-organized projecting patterns, the Si mask can be processed by using a C-based mask.

In the same way as for the diblock copolymer, dry etching is applicable when performing micropatterning such that etching in the thickness direction of the projecting patterns is significant with respect to etching in the widthwise direction. Plasmas required for dry etching can be generated by various methods such as capacitive coupling, inductive coupling, electron cyclotron resonance, and multi-frequency superposition coupling. Also, to adjust the pattern dimensions in order to obtain desired projecting patterns, it is possible to set parameters such as the process gas pressure, gas flow rate, plasma input power, substrate temperature, chamber ambient, and ultimate vacuum degree.

When stacking a metal material in order to increase the etching selectivity, an etching can properly be selected. Examples of the etching gas are fluorine-based gases such as CF₄, C₂F₆, C₃F₆, C₃F₈, C₅F₈, C₄F₈, ClF₃, CCl₃F₅, C₂ClF₅, CCBrF₃, CHF₃, NF₃, and CH₂F₂, and chlorine-based gases such as Cl₂, BCl₃, CCl₄, and SiCl₄. Other various gases such as H₂, N₂, Br₂, HBr, NH₃, CO, C₂H₄, He, Ne, Ar, Kr, and Xe can also be applied. It is also possible to use a gas mixture obtained by mixing two or more of these gases in order to adjust the etching rate or etching selectivity. The fluorine-based gases can readily remove Si, Ti, V, Mn, Co, Ru, Ta, Hf, and the like. The chlorine-based gases can remove Al, Cr, Mo, Ni, Cu, and the like. The metal mask layer can be processed with a high selectivity by combining these gases. Note that patterning can be performed by wet etching if it is possible to secure the etching selectivity and suppress etching in the widthwise direction. Similarly, physical etching such as ion milling can be performed.

### Release Layer Patterning Step

Subsequently, as shown in FIG. 14, patterned release layers 3′ are obtained by transferring the projecting patterns 6′ onto the release layer 3. The projecting patterns need only be transferred by etching in the same manner as for the metal mask layer. However, the release layer 3 may dissolve to collapse the metal mask layer if wet etching is performed. Accordingly, pattern transfer can be performed by dry etching.

When performing dry etching by using a chemically active gas, modification on the surface of the polymeric release layer is desirably reduced for the sake of manufacture. Since the release layer is made of a polymeric material, the dry etching resistance is lower than that of a metal material, and this facilitates transferring the projecting patterns. On the other hand, if the surface is modified by etching, the solubility to an organic solvent and water tends to decrease. For example, when dry etching using a fluorine-based gas is performed in the same manner as when removing a Si metal mask, the surface of the polymeric release layer is modified by the etching gas and becomes sparingly soluble in an organic solvent and water. This significantly deteriorates the removability of the mask. In this case, it is possible to properly select an etching gas, e.g., avoid the deterioration of the removability by performing dry etching using O₂ gas.

### Magnetic Recording Layer Patterning Step

Then, as shown in FIG. 15, the projecting patterns 6′ are transferred onto the perpendicular magnetic recording layer 2 below the release layers 3′, thereby obtaining the patterned perpendicular magnetic recording layers 2′. To form magnetically isolated dots, a typical method is to form projecting patterns by applying above-mentioned reactive ion etching or milling. In this case, patterning can be performed by a method of applying CO or NH₃ as an etching gas, or by ion milling using an inert gas such as Ar.

When transferring the projecting patterns onto the perpendicular magnetic recording layer by ion milling, it is desirable to suppress a redeposition component (a byproduct scattered toward the mask sidewalls by etching or milling). Since this redeposition component adheres around the projecting patterns, the projecting patterns increase the dimensions and fill the grooves. To obtain divided perpendicular magnetic recording layer patterns, therefore, it is desirable to reduce the redeposition component as soon as possible. Also, if the redeposition component produced when the perpendicular magnetic recording layer below the release layer is etched covers the side surfaces of the release layer, the release layer is not exposed to the release solution any longer, and the removability deteriorates. Accordingly, the redeposition component may be little.

When performing ion milling to the perpendicular magnetic recording layer, the redeposition component on the sidewalls can be reduced by changing the ion incident angle. In this case, redeposition can be suppressed within the range of 20° to 70°, although an optimal incident angle changes in accordance with the mask height. Also, the incident angle can appropriately be changed during milling.

### Removing Step

Subsequently, as shown in FIG. 16, the mask patterns 3′, 4′, 9′, and 6′ on the perpendicular magnetic recording layers 2′ are removed together with the release layers 3′, thereby obtaining the patterned perpendicular magnetic recording medium 10′ including the substrate 1 and the perpendicular magnetic recording layers 2′ having the projecting patterns. It is possible to select a polymeric material soluble in an organic solvent or water as the release layers 3′.

Various solutions can be used as the release solution. Examples are acetone, isobutyl alcohol, isopropyl alcohol, ethanol, methanol, butanol, ethyleneglycol monoethyl ether, ethyleneglycol monoethyletheracetate, ethyleneglycol monomethyletheracetate, methyl acetate, ethyl acetate, butyl acetate, methyl isobutyl ketone, methyl ethyl ketone, cyclohexanone, propyleneglycol monomethyletheracetate, tetrahydrofuran, anisole, xylene, toluene, and tetralin.

Also, when performing removal, various methods using the above-mentioned solutions are applicable. Examples are dipping, paddling, spinning, and vaporization. It is also possible to perform removal using scrubbing or ultrasonic waves.

Furthermore, the solubility of the polymeric release layer can be adjusted by properly setting the solution temperature. Ozone water or the like can be used when using water. Note that if it is difficult to remove water remaining on the sample surface, it is possible to dip the sample in a highly volatile organic solvent compatible with water to replace water with the organic solvent, and then dry the sample.

### Protective Layer Formation Step

As shown in FIG. 17, a protective layer 8 can be formed on the perpendicular magnetic recording layers 2′. The protective layer 8 has the effect of preventing corrosion and deterioration of the perpendicular magnetic recording layers 2′, and also has the effect of preventing damage to the medium surface when a magnetic head comes in contact with the recording medium. Examples of the protective layer material are materials containing C, Pd, SiO₂, and ZrO₂. Carbon can be classified into sp²-bonded carbon (graphite) and sp³-bonded carbon (diamond). Sp³-bonded carbon is superior in durability and corrosion resistance, and sp²-bonded carbon is superior in flatness. Carbon is normally deposited by sputtering using a graphite target, and amorphous carbon containing both sp²-bonded carbon and sp³-bonded carbon is deposited. Carbon in which the ratio of sp³-bonded carbon is high is called diamond-like carbon (DLC). DLC is superior in durability, corrosion resistance, and flatness, and usable as the protective layer of the perpendicular magnetic recording layer.

The film thickness of the protective layer may be 2 nm or more in order to maintain the coverage, and 10 nm or less in order to maintain the signal S/N.

Furthermore, a lubricating layer can be formed on the protective layer. Examples of a lubricant used in the lubricating layer are perfluoropolyether, alcohol fluoride, and fluorinated carboxylic acid. By the process described above, the perpendicular magnetic recording medium 10′ in which the patterns are formed on the substrate is obtained.

### Second Embodiment

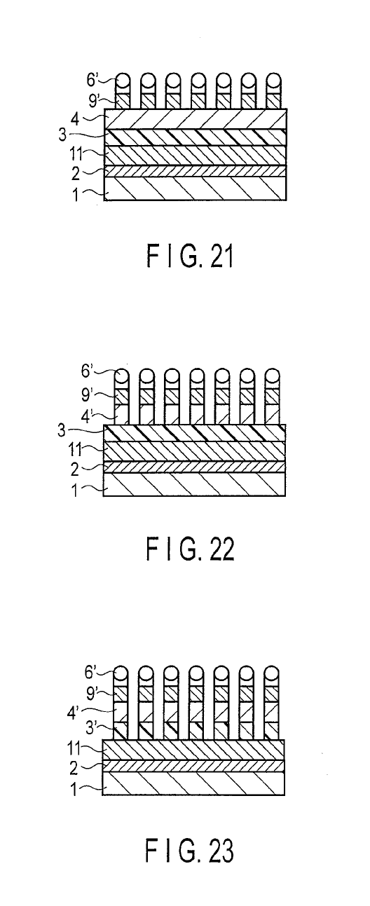

FIGS. 18, 19, 20, 21, 22, 23, 24, 25, 26, and 27 are exemplary sectional views showing examples of manufacturing steps of a magnetic recording medium according to the second embodiment.

FIGS. 18, 19, 20, 21, 22, 23, 25, and 26 are the same as FIGS. 9, 10, 11, 12, 13, 14, 15, and 16 except that a metal intermediate mask layer 11 is formed between a perpendicular magnetic recording layer 2 and polymeric release layer 3.

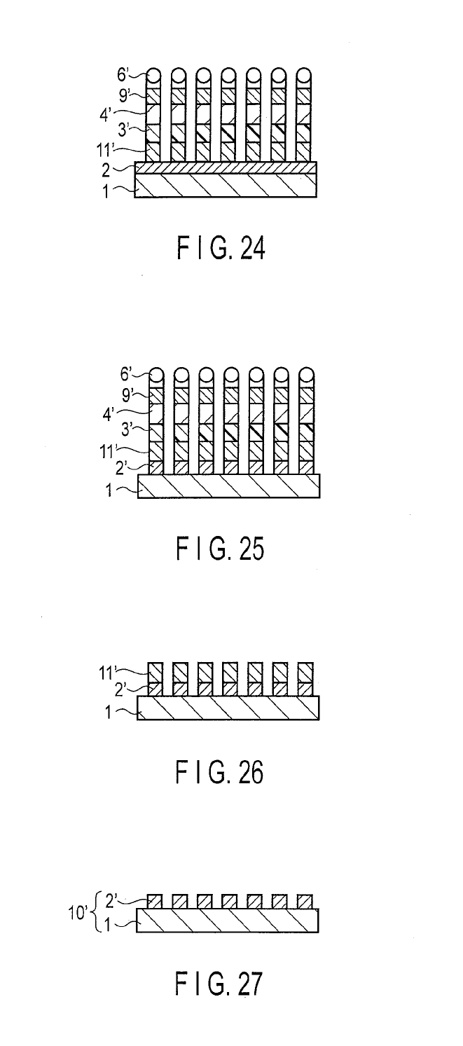

A method of manufacturing the magnetic recording medium according to the second embodiment can form a magnetic recording medium 10′ having projecting patterns in the same manner as in the first embodiment shown in FIGS. 9, 10, 11, 12, 13, 14, 15, 16, and 17, except that this method forms the metal intermediate mask layer 11 between the perpendicular magnetic recording layer 2 and polymeric release layer 3 as shown in FIG. 18, further includes a step (FIG. 24) of transferring the projecting patterns onto the intermediate mask layer 11, between a step (FIG. 23) of transferring the projecting patterns onto the polymeric release layer 3, and a step (FIG. 25) of transferring the projecting patterns onto the perpendicular magnetic recording layer 2, and further includes a step (FIG. 27) of removing the metal intermediate mask layer 11 by etching after a step (FIG. 26) of removing the polymeric release layer 3. Since most particles on a mask 4 can be removed from the substrate by the removal of the polymeric release layer 3, the mask residue can further be reduced by further performing removal by dry etching.

The metal intermediate mask layer 11 can be removed by applying dry etching such as reactive ion etching or Ar ion milling. Since damage to the perpendicular magnetic recording layer when the metal intermediate mask layer is removed may be as small as possible, an intermediate mask layer material and etching gas species capable of achieving this are selected. Examples of the mask material are Ni, Ta, Cu, Cr, Si, Zn, and Ti. It is possible to use, e.g., an oxide, nitride, boride, or carbide of any of these materials, or an alloy containing two or more of these materials. Also, the material used in the metal mask layer and the material used in the metal intermediate mask layer can satisfy ER1≦ER2 where ER1 and ER2 are respectively the ion milling rates of the former and latter. This is so because the etching mask of the magnetic recording medium is desirably a low-rate strong mask layer, whereas the mask of the lower layer is desirably readily removable after the magnetic recording layer is processed. Examples of a mask layer material combination meeting this condition are Si/Ni, Si/Ti, Si/Ta, and Ni/Cr from the substrate side.

### Third Embodiment

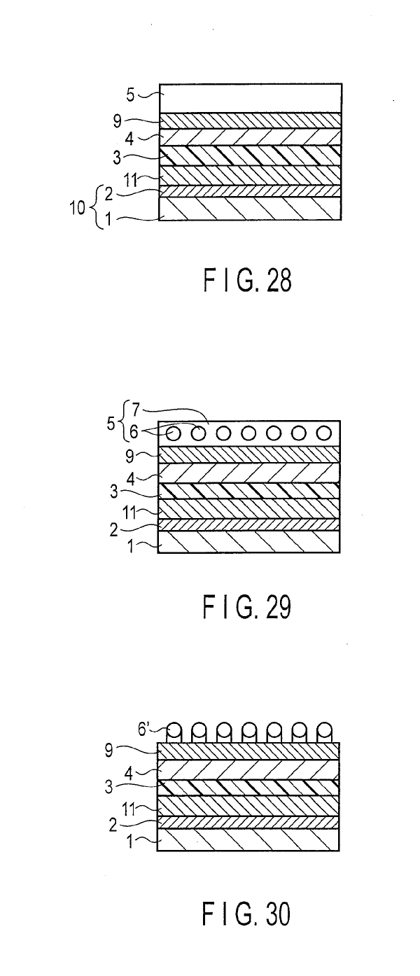

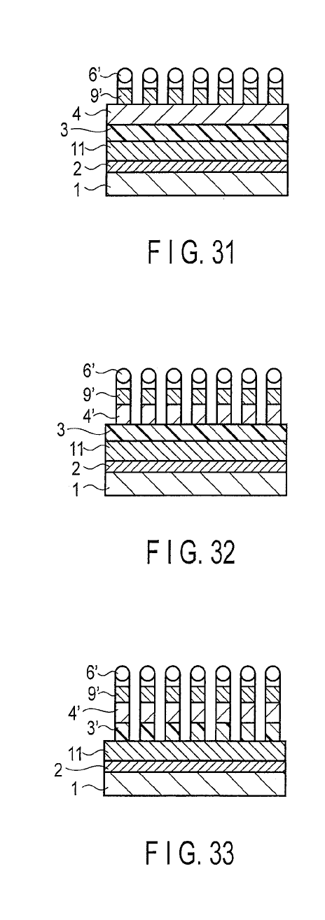

FIGS. 28, 29, 30, 31, 32, 33, 34, 35, and 36 are exemplary sectional views showing examples of manufacturing steps of a magnetic recording medium according to the third embodiment.

FIGS. 28, 29, 30, 31, 32, and 33 are the same as FIGS. 9, 10, 11, 12, 13, and 14 except that a metal intermediate mask layer 11 is formed between a perpendicular magnetic recording layer 2 and polymeric release layer 3.

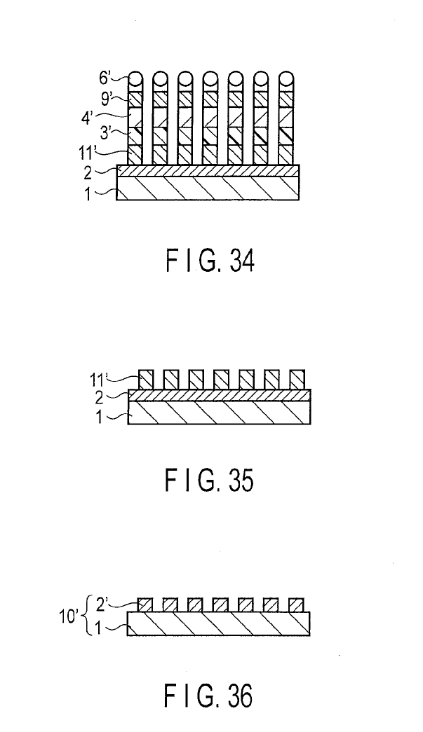

A method of manufacturing the magnetic recording medium according to the third embodiment can form a magnetic recording medium 10′ having projecting patterns in the same manner as in the first embodiment, except that the method forms the metal intermediate mask layer 11 between the perpendicular magnetic recording layer 2 and polymeric release layer 3 as shown in FIG. 28, performs a step (FIG. 36) of transferring the projecting patterns onto the perpendicular magnetic recording layer 2 via the metal intermediate mask layer 11 and removing the metal intermediate mask layer 11, not before but after a step (FIG. 35) of removing the polymeric release layer 3, and further includes a step (FIG. 34) of transferring the projecting patterns onto the intermediate mask layer 11, between a step (FIG. 33) of transferring the projecting patterns onto the polymeric release layer 3 and a step (FIG. 35) of removing the polymeric release layer 3. Before the projecting patterns are transferred onto the perpendicular magnetic recording layer, therefore, the polymeric release layer and the mask layer formed on it are removed by an organic solvent or water. In addition, the metal intermediate mask layer is removed after the projecting patterns are transferred onto the perpendicular magnetic recording layer. Particles on the mask can be removed by the removal of the polymeric release layer as in the second embodiment. In the third embodiment, when performing pattern transfer by using the metal intermediate mask layer having the projections, pattern transfer to the perpendicular magnetic recording layer reduces the metal intermediate mask layer and decreases its height, so the reduced metal intermediate mask layer need only be removed after the perpendicular magnetic recording layer is patterned. This makes it possible to reduce damage inflicted to the perpendicular magnetic recording layer by etching, and further improve the characteristics of the magnetic recording medium compared to the second embodiment.

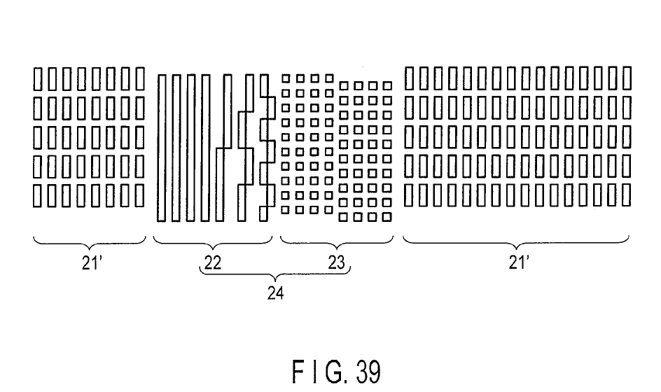

FIG. 39 is a view showing examples of recording bit patterns in the circumferential direction of the magnetic recording medium.

As shown in FIG. 39, the projecting patterns of the magnetic recording layer are roughly classified into a recording bit area 21′ for recording data corresponding to 1 and 0 of digital signals, and a so-called servo area 24 including preamble address patterns 22 serving as a magnetic head positioning signal, and burst patterns 23. These projecting patterns are formed as in-plane patterns. Note that the patterns in the servo area shown in FIG. 39 need not have rectangular shapes. For example, all the patterns may also be replaced with dot-like patterns.

When using the magnetic recording medium manufacturing methods according to the first to third embodiments, the removability of the mask patterns improves, and the deterioration of the magnetic characteristics is suppressed.

### Examples

The embodiments will be explained in more detail below by way of their examples.

### Example 1

First, a perpendicular magnetic recording layer was formed on a doughnut substrate by DC sputtering. That is, the perpendicular magnetic recording layer was obtained by sequentially depositing a 10-nm thick NiTa base layer/4-nm thick Pd base layer/20-nm thick Ru base layer/5-nm thick CoPt recording layer from the substrate side, and finally forming a 3-nm thick Pd protective layer, by setting the gas pressure at 0.7 Pa and the input power at 500 W.

Then, a polymeric release layer was formed on the perpendicular magnetic recording layer. That is, commercially available PMMA (manufactured by NIPPON KAYAKU) was used as the polymeric release layer, and anisole was used as a solvent. After the weight ratio was adjusted at PMMA:anisole=1:2, the substrate was coated with the solution by spin coating. The rotational speed was set at 3,000 rpm after the solution was dropped, thereby forming a 10-nm thick polymeric release layer. The average surface roughness of the polymeric release layer was small, i.e., Ra=about 0.3 nm.

Subsequently, a metal mask layer was formed on the polymeric release layer. That is, a 20-nm thick Ta film was selected as the metal mask layer and deposited by sputtering at an Ar gas flow rate of 35 sccm, an Ar gas pressure of 0.3 Pa, and an input power of 200 W by using a facing target DC sputtering apparatus. A transfer layer for facilitating pattern transfer was formed on the metal mask layer. The transfer layer was made of C as the same material as that of a base polymer of a self-organized layer material, and deposited in the same manner as for the metal mask layer by facing target DC sputtering. The film thickness was set to 5 nm.

Then, a self-organized layer was deposited on the transfer layer. First, the substrate was coated with a block copolymer solution. As the block copolymer solution, a solution prepared by dissolving a block copolymer containing polystyrene and polydimethylsiloxane in a coating solvent was used. The molecular weights of polystyrene and polydimethylsiloxane were 11,700 and 2,900, respectively. Anisole was used as the solvent, and the polymer solution was prepared at a weight percent concentration of 1.5%. The mask was coated with this solution by spin coating at a rotational speed of 5,000 rpm, thereby forming a mono-layered self-organized layer. In addition, thermal annealing was performed to cause micro phase separation into polydimethylsiloxane dot patterns and a polystyrene matrix inside the self-organized layer. This thermal annealing was performed at a temperature of 170° C. for 12 hrs in a low-pressure ambient at an internal pressure of 0.2 Pa by using a vacuum heating furnace, thereby forming a micro phase-separated structure inside the self-organized layer. Note that this annealing may also be so-called solvent annealing by which a sample is exposed to an organic solvent ambient. This baking contributes not only to the formation of the micro phase-separated structure in the self-organized layer, but also to the planarization of the aforementioned polymeric release layer. Heating the substrate planarized the fluidized polymeric release layer, and improved the macro projection unevenness.

Subsequently, projecting patterns were formed by dry etching based on the phase-separated patterns. Dry etching was performed by inductively coupled plasma reactive ion etching. The process gas pressure was set at 0.1 Pa, and the gas flow rate was set at 5 sccm. First, to remove polydimethylsiloxane in the surface layer of the self-organized layer, etching was performed using CF₄ gas as an etchant at an antenna power of 50 W and a bias power of 5 W for 7 sec. Then, to transfer the projecting patterns onto polystyrene as the matrix and the C transfer layer below the polymer layer, etching was performed using O₂ gas as an etchant at an antenna power of 100 W and a bias power of 5 W for 110 sec. Since the O₂ etchant used to remove polystyrene also etched the C mask as a lower layer, etching stopped at the Ta metal mask layer as a stopper layer. Consequently, the projecting patterns made of the diblock copolymer were formed on the metal mask layer via the C transfer layer.

Furthermore, the projecting patterns were transferred by etching the Ta metal mask layer. In this etching of the Ta metal mask layer, the projecting patterns were formed on the Ta mask by performing etching for 25 sec by using CF₄ gas as an etchant at a process gas pressure of 0.1 Pa, an antenna power of 100 W, and a bias power of 30 W. This etching was stopped above the polymeric release layer in order to avoid modification of the polymeric release layer.

Projecting pattern transfer to the polymeric release layer was performed by etching using O₂ gas. That is, the projecting patterns were transferred onto the polymeric release layer by performing etching for 12 sec at a process gas pressure of 0.1 Pa, an antenna power of 100 W, and a bias power of 5 W.

Subsequently, the projecting patterns were transferred onto the perpendicular magnetic recording layer. The perpendicular magnetic recording layer was patterned by Ar ion milling. That is, milling was performed for 56 sec at an Ar ion acceleration voltage of 300 V, a gas flow rate of 3 sccm, and a process pressure of 0.1 Pa, thereby transferring the projecting patterns onto the 5-nm thick CoPt magnetic film.

To remove the mask from the surface of the perpendicular magnetic recording layer having the projections, the polymeric release layer was removed by using an organic solvent.

In this removal of the polymeric release layer, the sample was dipped in anisole as a solvent for a PMMA film for 3 min, and ultrasonic cleaning was performed, thereby removing the polymeric release layer and upper mask layer. Finally, a magnetic recording medium was obtained by depositing a 2-nm thick DLC film, and then forming a 1.5-nm thick perfluoropolyether-based lubricating film.

The coercive force of the obtained magnetic recording medium was measured using a polar Kerr effect measurement device, and found to be 5.2 kOe. Table 1 (to be presented later) shows the obtained result.

In addition, damage inflicted to the CoPt perpendicular magnetic recording layer by the organic solvent was evaluated. A CoPt in-plane continuous film having no projecting patterns was used as a sample.

Since a Co-based alloy material is sparingly soluble in an organic solvent, deterioration of the magnetic characteristics is very small, and favorable recording/reproduction characteristics can be implemented.

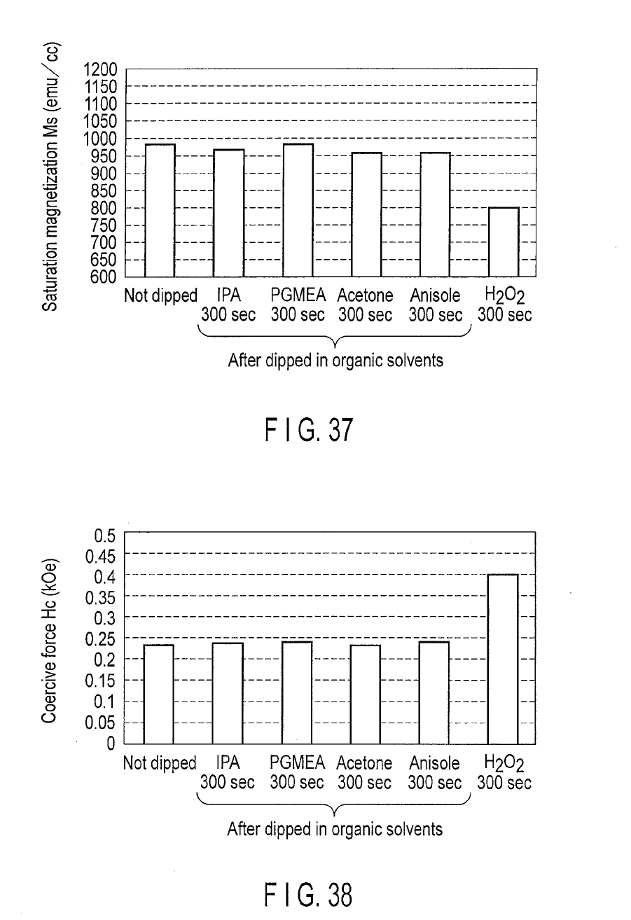

FIGS. 37 and 38 show changes in magnetostatic characteristics before and after the magnetic recording material was dipped in organic solvents.

That is, a 10-nm thick CoPt perpendicular magnetic recording layer deposited on a substrate was used as a sample, and dipped in various organic solvents. FIG. 37 shows changes in saturation magnetization, and FIG. 38 shows changes in coercive force.

The organic solvents used are isopropylalcohol (IPA), propyleneglycol monomethyletheracetate (PGMEA), acetone, and anisole. The sample was dipped in these solvents for 300 sec, and dried by N₂ blow. After that, the magnetostatic characteristics were measured using a VSM (Vibrating Sample Magnetometer). For comparison, FIGS. 37 and 38 also show the results when the sample was not dipped in any solution, and the results when the sample was dipped in hydrogen peroxide as a conventional release solution for 300 sec.

As shown in FIGS. 37 and 38, there were almost no changes in saturation magnetization and coercive force before and after the sample was dipped in any organic solvent, indicating that the influence of the organic solvent on the perpendicular magnetic recording layer was extremely small. Accordingly, there was almost no deterioration in recording/reproduction characteristics when wet removal was performed by using the organic solvent, and a medium having excellent magnetic characteristics was obtained.

As described above, a magnetic recording medium having good magnetostatic characteristics was obtained by removing the mask by using, as a release solution, the organic solvent that inflicted almost no removal damage to the recording layer. It was also possible to obtain a medium having little residue and high in-plane uniformity compared to the conventional removing methods.

### Example 2

In Example 2, a magnetic recording medium was obtained by performing removal by using a polymeric release layer and organic solvent following the same procedure as in Example 1, except that the thickness of the polymeric release layer on a substrate was adjusted.

The pattern end portion is highly removable because it is readily exposed to a release solution. Therefore, the thickness of the polymeric release layer deposited on the substrate was changed in the radial direction. In this example, the release layer was formed to satisfy t₁≦t₂≦t₃ where t₁ was the thickness of the release layer near the substrate center, t₂ was the thickness near the inner circumference of the substrate, and t₃ was the thickness near the outer circumference of the substrate.

More specifically, t₁=9.2 nm, t₂=10.4 nm, and t₃=11.7 nm.

When removal was performed using an organic solvent in the same manner as in Example 1, removal from the pattern end portion readily advanced, i.e., the removal rate increased. It was also possible to reduce the amount of unremoved residue.

The coercive force was measured in the same manner as in Example 1 by using the obtained magnetic recording medium, and found to be 5.34 kOe. Table 1 (to be presented later) shows the obtained result.

### Example 3

In Example 3, a magnetic recording medium was obtained following the same procedure as in Example 1 except that a water-soluble polymeric material was applied as a polymeric release layer, and removal was performed using water.

Polyvinylpyrrolidone (SAFIER manufactured by TOKYO OHKA KOGYO) was selected as the water-soluble polymeric material to be formed on a perpendicular magnetic recording layer. After a nonion-based, fluorine-containing surfactant was added to the material, spin coating was performed at a rotational speed of 4,600 rpm such that the thickness was 10 nm. The surface roughness after coating was good, i.e., Ra=about 0.3 nm.

After projecting patterns were transferred, the sample was dipped in water at 28° C., and removal was performed by ultrasonic cleaning. Even when using water in the same manner as in Example 1, the removability was high, and a magnetic recording medium having few particles was obtained. Likewise, almost no deterioration was found in the magnetic characteristics of the perpendicular magnetic recording layer, and favorable read/write characteristics were confirmed.

The coercive force was measured in the same manner as in Example 1 by using the obtained magnetic recording medium, and found to be 5.11 kOe. Table 1 (to be presented later) shows the obtained result.

### Example 4

In Example 4, a water-soluble polymeric release layer was used, and a magnetic recording medium was obtained following the same procedure as in Example 3 except that pre-wet processing was performed to improve the removability before removal was performed using water.

A release solution hardly penetrates into recesses of projecting patterns, and this deteriorates the removability. However, pre-wet can solve this problem. To evenly pre-wet projection side surfaces about a few ten nm thick, adhesion of waterdrops was utilized in this example. First, a substrate is cooled by using dry ice, and the substrate temperature is returned to room temperature, thereby causing condensation on the substrate surface. Since this condensation is adsorption of water occurring on a molecular level on the projection side surfaces, waterdrops evenly adhere to the side surfaces of the projecting patterns. Therefore, the exposed water-soluble polymeric release layer is pre-wet with the waterdrops, and the mask patterns can easily be removed by then dipping the sample in water. When the sample was dipped in 28° C. water, in the same manner as in Example 3, it was possible to extremely easily remove the mask, and the amount of unremoved residue was also small.

The coercive force was measured in the same manner as in Example 1 by using the obtained magnetic recording medium, and found to be 5.46 kOe. Table 1 (to be presented later) shows the obtained result.

### Example 5

Example 5 was the same as Example 1 except that an intermediate metal mask layer was formed between a perpendicular magnetic recording layer and polymeric release layer, and, after projecting patterns were transferred onto the perpendicular magnetic recording layer, the polymeric release layer was removed, and the intermediate metal mask layer was removed.

A Si film was selected as the metal intermediate mask layer, and deposited to have a thickness of 10 nm by facing target DC sputtering at a gas pressure of 0.7 Pa and an input power of 500 W. After projections were transferred onto the perpendicular magnetic recording layer and the polymeric release layer was removed, the metal intermediate mask layer was removed by etching. In this etching, the Si film was removed at an antenna power of 50 W and a bias power of 2 W by using CF₄ gas as an etchant. In the manufactured magnetic recording medium, the amounts of unremoved residue and particles were small, and the in-plane uniformity was high.

The coercive force was measured in the same manner as in Example 1 by using the obtained magnetic recording medium, and found to be 5.0 kOe. Table 1 (to be presented later) shows the obtained result.

### Example 6

Example 6 was the same as Example 1 except that an intermediate metal mask layer was formed between a perpendicular magnetic recording layer and polymeric release layer, and, after projecting patterns were transferred onto the metal intermediate mask layer, the polymeric release layer was removed, and the projecting patterns were transferred onto the perpendicular magnetic recording layer by using the metal intermediate mask layer.

Ta₂O₅ was selected as the metal intermediate mask layer, and deposited to have a thickness of 30 nm by facing target DC sputtering at a gas pressure of 0.7 Pa and an input power of 500 W. After the polymeric release layer was removed, the Ta film was used as a mask to transfer the projecting patterns onto the perpendicular magnetic recording layer by ion milling. Since the Ta₂O₅ film disappeared when projections were formed in the perpendicular magnetic recording layer, a flat medium in which the projections of the perpendicular magnetic recording layer were exposed was obtained. In the manufactured magnetic recording medium, the amount of particles was small, and the in-plane uniformity was high.

The coercive force was measured in the same manner as in Example 1 by using the obtained magnetic recording medium, and found to be 5.1 kOe. Table 1 (to be presented later) shows the obtained result.

### Example 7

Example 7 was the same as Example 1 except that a thick polymeric release layer was formed on a perpendicular magnetic recording layer, and the film thickness was reduced by etching.

Since local pinholes readily form when uniformly forming a thin film about a few nm thick by coating, the polymeric release layer was formed to have a relatively large initial film thickness. In this example, a PMMA film was used. After a coating solution in which weight ratio PMMA:anisole=2:3 was prepared, a substrate was coated with a 30-nm thick film by spin coating. Subsequently, etching was performed at an antenna power of 100 W, a bias power of 5 W, and a gas flow rate of 20 sccm by using O₂ gas as an etchant, thereby reducing the release layer thickness to 6 nm.

The manufactured medium had few pinholes and high in-plane uniformity. The coercive force was measured in the same manner as in Example 1 by using the obtained magnetic recording medium, and found to be 5.0 kOe. Table 1 (to be presented later) shows the obtained result.

### Comparative Example 1

Comparative Example 1 was the same as Example 1 except that a carbon film was used as a mask layer.

The carbon film was deposited to have a thickness of 25 nm by facing target DC sputtering. The carbon film deposited on a polymeric release layer produced macro projections by stress, thereby decreasing the in-plane uniformity. In this state, the surface roughness significantly deteriorated, i.e., Ra=about 3 nm. In addition, when projecting patterns were transferred by etching, the variation in pattern density resulting from the surface roughness made uniform processing difficult.

The coercive force was measured in the same manner as in Example 1 by using the obtained magnetic recording medium, and found to be 2.1 kOe. Table 1 (to be presented later) shows the obtained result.

### Comparative Example 2

Comparative Example 2 was the same as Example 1 except that a polymer film was used as a mask layer.

Polystyrene was used as the polymer film, and a coating solution was prepared by using propyleneglycol monomethyletheracetate as a solvent. The concentration of the coating solution was set at 1.0 wt. %. After the coating solution was dropped onto a perpendicular magnetic recording layer, a 20-nm thick film was formed by spin coating.

When using this polystyrene film as a mask layer, the etching resistance was extremely low, and almost no projecting patterns could be transferred.

The coercive force was measured in the same manner as in Example 1 by using the obtained magnetic recording medium, and found to be 0.6 kOe. Table 1 below shows the obtained result.

TABLE 1

| | Coercive force |
|---|---|
| | (kOe) |
| Example 1 | 5.2 |
| Example 2 | 5.34 |
| Example 3 | 5.11 |
| Example 4 | 5.46 |
| Example 5 | 5.0 |
| Example 6 | 5.1 |
| Example 7 | 5.0 |
| Comparative Example 1 | 2.1 |
| Comparative Example 2 | 0.6 |

The magnetic characteristics after projection patterning of the examples were better than those of Comparative Examples 1 and 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium manufacturing method comprising:
forming a magnetic recording layer on a substrate;
forming a release layer made of a polymeric material on the magnetic recording layer;
forming a mask layer made of at least one of a metal and a metal compound on the release layer;
forming a self-organized layer made of a block copolymer having at least two of polymer chains on the mask layer;
annealing the substrate to planarize the release layer and form a micro phase-separated structure in the self-organized layer;
selectively removing one of a polymer layer of the micro phase-separated structure, thereby forming projecting patterns by a remaining polymer layer;
transferring the projecting patterns onto the mask layer;
transferring the projecting patterns onto the release layer;
transferring the projecting patterns onto the magnetic recording layer; and
removing the release layer by a solvent, and removing a remaining mask layer from a surface of the magnetic recording layer.

2. The method according to claim 1, further comprising forming an intermediate mask layer before the forming the release layer,
wherein the projecting patterns are transferred onto the intermediate mask layer before the transferring the projecting patterns onto the magnetic recording layer, and
the intermediate mask layer is removed from the surface of the magnetic recording layer after the removing the release layer.

3. The method according to claim 1, wherein in the annealing the substrate, an annealing temperature is lower than a thermal decomposition temperature T_{d} of the release layer.

4. The method according to claim 1, wherein an annealing temperature of the substrate is lower than an order-disorder transition temperature ODT of the self-organized layer.

5. The method according to claim 1, wherein a film thickness of the release layer is 5 to 20 nm.

6. The method according to claim 1, wherein the mask layer comprises not less than two layers.

7. The method according to claim 6, further comprising forming a plurality of units each of which is a stack of the release layer and the mask layers.

8. The method according to claim 1, wherein a film thickness of the release layer is decreased by etching the release layer.

9. The method according to claim 1, wherein the solvent is one of an organic solvent and water.

10. A magnetic recording medium manufacturing method comprising:
forming a magnetic recording layer on a substrate;
forming a first mask layer made of at least one of a metal and a metal compound on the magnetic recording layer;
forming a release layer made of a polymeric material on the first mask layer;
forming a second mask layer made of at least one of a metal and a metal compound on the release layer;
forming a self-organized layer made of a block copolymer having at least two of polymer chains on the second mask layer;
annealing the substrate to planarize the release layer and form a micro phase-separated structure in the self-organized layer;
selectively removing one of a polymer layer of the micro phase-separated structure formed in the self-organized layer, thereby forming projecting patterns by a remaining polymer layer;
transferring the projecting patterns onto the second mask layer;
transferring the projecting patterns onto the release layer by etching by using the second mask layer;
transferring the projecting patterns onto the first mask layer;
removing the release layer by using a solvent, and removing the second mask layer from a surface of the first mask layer;
transferring the projecting patterns onto the magnetic recording layer; and
removing the first mask layer from a surface of the magnetic recording layer.

11. The method according to claim 10, wherein in the annealing the substrate, an annealing temperature is lower than a thermal decomposition temperature Td of the release layer.

12. The method according to claim 10, wherein an annealing temperature of the substrate is lower than an order-disorder transition temperature ODT of the self-organized layer.

13. The method according to claim 10, wherein a film thickness of the release layer is 5 to 20 nm.

14. The method according to claim 10, wherein the mask layer comprises not less than two layers.

15. The method according to claim 14, further comprising forming a plurality of units each of which is a stack of the release layer and the mask layers.

16. The method according to claim 10, wherein a film thickness of the release layer is decreased by etching the release layer.

17. The method according to claim 10, wherein the solvent is one of an organic solvent and water.

18. A magnetic recording medium manufactured by a method comprising:
forming a magnetic recording layer on a substrate;
forming a release layer made of a polymeric material on the magnetic recording layer;
forming a mask layer made of at least one of a metal and a metal compound on the release layer;
forming a self-organized layer made of a block copolymer having at least two of polymer chains on the mask layer;
annealing the substrate to planarize the release layer and form a micro phase-separated structure in the self-organized layer;
selectively removing one of a polymer layer of the micro phase-separated structure, thereby forming projecting patterns by a remaining polymer layer;
transferring the projecting patterns onto the mask layer;
transferring the projecting patterns onto the release layer;
transferring the projecting patterns onto the magnetic recording layer; and
removing the release layer by a solvent, and removing a remaining mask layer from a surface of the magnetic recording layer.

19. The medium according to claim 18, wherein
the method further comprises forming an intermediate mask layer before the forming the release layer,
the projecting patterns are transferred onto the intermediate mask layer before the transferring the projecting patterns onto the magnetic recording layer, and
the intermediate mask layer is removed from the surface of the magnetic recording layer after the removing the release layer.

20. A magnetic recording medium manufactured by a method comprising:
forming a magnetic recording layer on a substrate;
forming a first mask layer made of at least one of a metal and a metal compound on the magnetic recording layer;
forming a release layer made of a polymeric material on the first mask layer;
forming a second mask layer made of at least one of a metal and a metal compound on the release layer;
forming a self-organized layer made of a block copolymer having at least two of polymer chains on the second mask layer;
annealing the substrate to planarize the release layer and form a micro phase-separated structure in the self-organized layer;
selectively removing one of a polymer layer of the micro phase-separated structure formed in the self-organized layer, thereby forming projecting patterns by a remaining polymer layer;
transferring the projecting patterns onto the second mask layer;
transferring the projecting patterns onto the release layer by etching by using the second mask layer;
transferring the projecting patterns onto the first mask layer;
removing the release layer by using a solvent, and removing the second mask layer from a surface of the first mask layer;
transferring the projecting patterns onto the magnetic recording layer; and
removing the first mask layer from a surface of the magnetic recording layer.
